(19) United States
(12) Patent Application Publication
(10) Pub. No.: US 2011/0109122 A1
(43) Pub. Date: May 12, 2011

(54) CRASH MANAGEMENT SYSTEM, AND A METHOD OF MAKING SAME

(75) Inventors: EDVIN LIST CLAUSEN, Aabenraa (DK); Claus Hübel, Munchen (DE); Sascha Wendt, Flensburg (DE)

(73) Assignee: Benteler Automobiltechnik GmbH, Paderborn (DE)

(21) Appl. No.: 12/938,855

(22) Filed: Nov. 3, 2010

(30) Foreign Application Priority Data
Nov. 11, 2009 (NO) 20093323

(51) Int. Cl. B62D 21/15; B21D 43/28

(52) U.S. Cl. 296/187.03; 72/324; 293/102; 296/187.09

(57) ABSTRACT

In a method of producing a crash management system for a vehicle having at least one first cross-member, two crash absorbing components connected to the first cross member, a second cross-member is further integrated with the first cross-member, an extruded profile of closed or semi-closed configuration is cut to size and slit at locations where sections of the profile are to be separated. The sections are bent to a designed shape, and fixation mounts are subsequently provided in the profile.

### CROSS-REFERENCES TO RELATED APPLICATIONS

This application claims the priority of Norwegian Patent Application, Serial No. 20093323, filed Nov. 11, 2009, pursuant to 35 U.S.C. 119(a)-(d), the content of which is incorporated herein by reference in its entirety as if fully set forth herein.

### BACKGROUND OF THE INVENTION

The present invention relates to an impact absorbing member, and more particularly to a crash management system and a method for making a crash management system.

The following discussion of related art is provided to assist the reader in understanding the advantages of the invention, and is not to be construed as an admission that this related art is prior art to this invention.

Cars, particularly passenger cars, but also trucks and SUV's can include a crash management system to protect the front of cars in frontal impacts, and also to protect the rear end of the cars. In addition, the provision of a crash management system also enables to transfer forces and absorb crash energy to protect a vehicle main structure and also to protect pedestrians in the event of a collision with a vehicle.

Recently, the Insurance Institute for Highway safety (IIHS) set higher standards for crash protection, together with more severe packaging demands due to the current need for smaller and more energy-efficient cars. A key parameter to achieve the performances required is the geometry of the system, which again is achieved by the new forming.

Oftentimes, a vehicle collides with “soft” objects which also deform. In this case, it is very beneficial to provide a more expanded crash system, i.e. wider and/or higher in order to render the crash area larger. This is beneficial for a number of reasons (less aggressive interaction, higher crash force and more efficient energy dissipation may be introduced earlier in the crash).

It would be desirable and advantageous to provide an improved crash management system which obviates prior art shortcomings and is able to better handle a crash with hard objects such as walls, poles, etc., and overall affords better crash protection in the event of a collision at low speed impact at walking pace to high speed impact, and which allows a combination with other crash protecting systems.

### SUMMARY OF THE INVENTION

According to one aspect of the present invention, a crash management system for a vehicle includes a first cross-member, two crash absorbing components connected to the first cross member, and a second cross-members integrated with the first cross-member.

The present invention has the advantage of providing a crash management system of a geometry which improves strength and stiffness to weight ratio as compared to a traditional crash management system (mechanically assembled crash boxes and bumper beam(-s)) and also offers some advantages to current automobile packaging. Further, the invention represents a cost-efficient solution as plural process steps related to assembly of several sub-components can be avoided.

This is related to the structure of the crash system which is now more homogenous than earlier (less parts, less assembly interfaces), resulting in an improved force transfer between the parts as well as less risk of separation between the parts in the interfaces between them during severe crash deformations. “Packaging room” in the vehicle is not impaired, thus providing space and fixing arrangements for other objects and functions such as lights, sensors and ducting for cooling air and so on.

As a result of a crash management system according to the present invention, air is allowed to flow from the front through/around the crash management system in a way that the vehicle can be cooled efficiently. In addition, damage and dangers due to crashes can be diminished, and other desirable effects will be achieved, such as reducing the overhang of the car, lessen the need for strength/stiffness of the main car body and so on. This again has the desired effect of reducing weight and bulk of the car, and positively influences costs of producing and operating (running) the car.

The present invention thus resolves prior art shortcomings by providing a crash management system which has a main first beam and a secondary beam which are functionally integrated with each other with means within the system during crash deformations. The main first beam and the secondary beam are able to support the crash deformation sequence of each other in order to ensure a predictable and optimized crash deformation. A crash management system according to the present invention is able to lead crash forces from one level to be dealt with as deformations on the part crash system of the other level through the connecting (integrating) means between the part crash systems. The crash management system covers a complete range of crash situations, ranging from the pedestrian impact to the high speed crashes. Advantageously, connections between the main first beam and the secondary beam in the crash systems may themselves be beams which, like the main and secondary beams, may take direct impact blows and be deformed to absorb energy, as well as distributing the forces of these blows to parts of the module where they are absorbed by further deformation.

The invention shows the following advantages:
reduction of components
reduction of assembly operations
function integration
possibilities of overall weight reduction
optimize airflow
match future vehicle styling
flexible design to meet various requirements

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic top view of a first embodiment of a crash management system according to the present invention;

FIG. 2 shows a side view of the crash management system of FIG. 1, taken along the line A-A in FIG. 1;

FIG. 3 shows a top, rear and side perspective view of the crash management system of FIG. 1,

FIG. 4 is a simplified, schematic illustration of a typical cross-section configuration of the crash management system, taken along a line B-B in FIG. 3;

FIG. 5 is a simplified, schematic illustration of another typical cross-section configuration of the crash management system;

FIG. 6 shows a top, rear and side perspective view of a second embodiment of a crash management system according to the present invention;

FIG. 7 is a simplified, schematic illustration of cross-section configuration of the crash management system of FIG. 6, taken along a line B-B in FIG. 6;

FIG. 8 shows a top, rear and side perspective view of a third embodiment of a crash management system according to the present invention;

FIG. 9 is a simplified, schematic illustration of cross-section configuration of the crash management system of FIG. 8, taken along a line B-B in FIG. 8;

FIG. 10 shows a top, rear and side perspective view of a fourth embodiment of a crash management system according to the present invention;

FIG. 11 is a simplified, schematic illustration of cross-section configuration of the crash management system of FIG. 10 taken along a line B-B in FIG. 10,

FIG. 12 is a schematic illustration of various manufacturing steps of making a crash management system in accordance to the present invention;

FIG. 13 shows a top, front and side perspective view of a variation of a crash management system as shown in FIG. 8, adapted for ventilation;

FIG. 14 is a simplified, schematic illustration, on an enlarged scale, of cross-section configuration of the crash management system of FIG. 13;

FIG. 15 is a simplified, schematic illustration, on an enlarged scale, of a variation of the cross-section configuration of the crash management system of FIG. 13;

FIG. 16 is a simplified, schematic illustration, on an enlarged scale, of another variation of the cross-section configuration of the crash management system of FIG. 13;

FIG. 17 shows a top, front and side perspective view of two crash management systems arranged at different vertical levels;

FIG. 18 is a simplified, schematic illustration of a cross-section through a crash management system having absorbing components attached thereto;

FIG. 19 is a simplified, schematic illustration of a cross-section through a crash management system having absorbing components integrated therein;

FIG. 20 shows a top, front and side perspective view of another variation of a crash management system as shown in FIG. 8, adapted for ventilation; and

FIG. 21 shows a top, front and side perspective view of yet another variation of a crash management system as shown in FIG. 8, adapted for ventilation.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

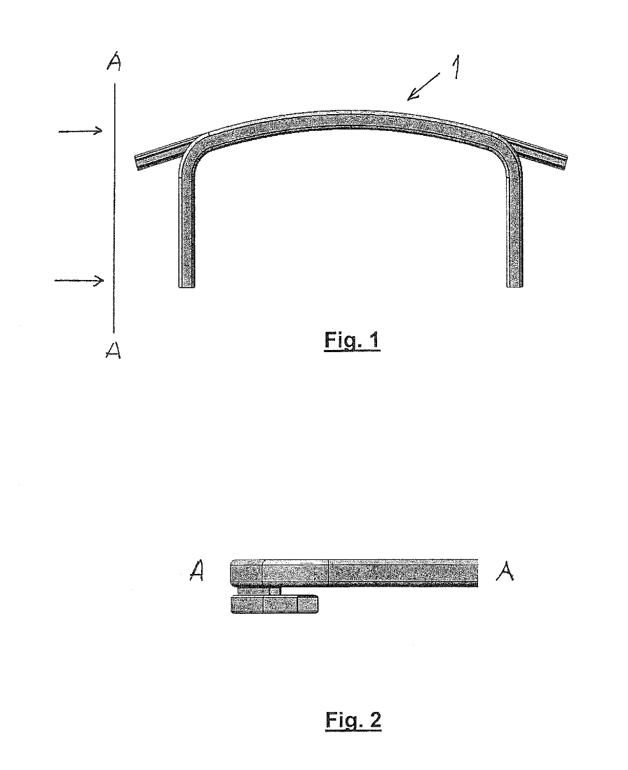

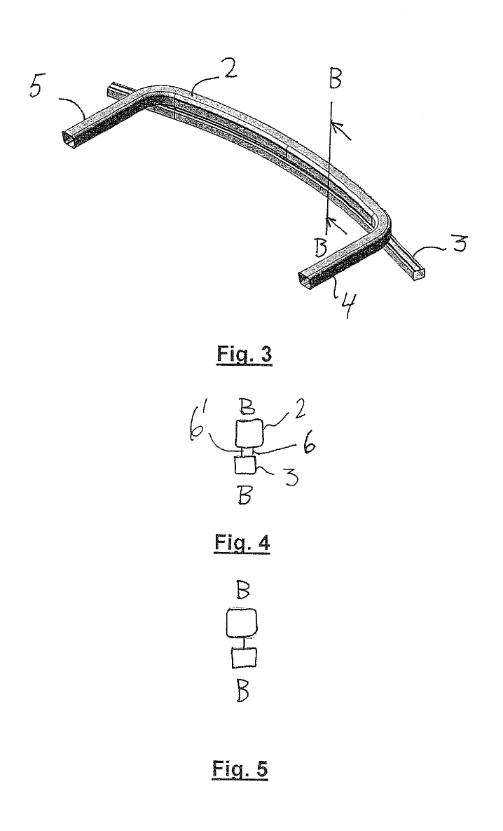

Turning now to the drawing, and in particular to FIG. 1, there is shown a schematic top view of a first embodiment of a crash management system according to the present invention, generally designated by reference numeral 1. FIG. 2 shows a side view of the crash management system 1, taken along the line A-A in FIG. 1. FIG. 3 depicts the crash management system 1 in a perspective view, while FIG. 4 depicts the cross-section configuration of the crash management system 1, taken along a line B-B in FIG. 3. In FIG. 5, there is shown an alternative cross section configuration.

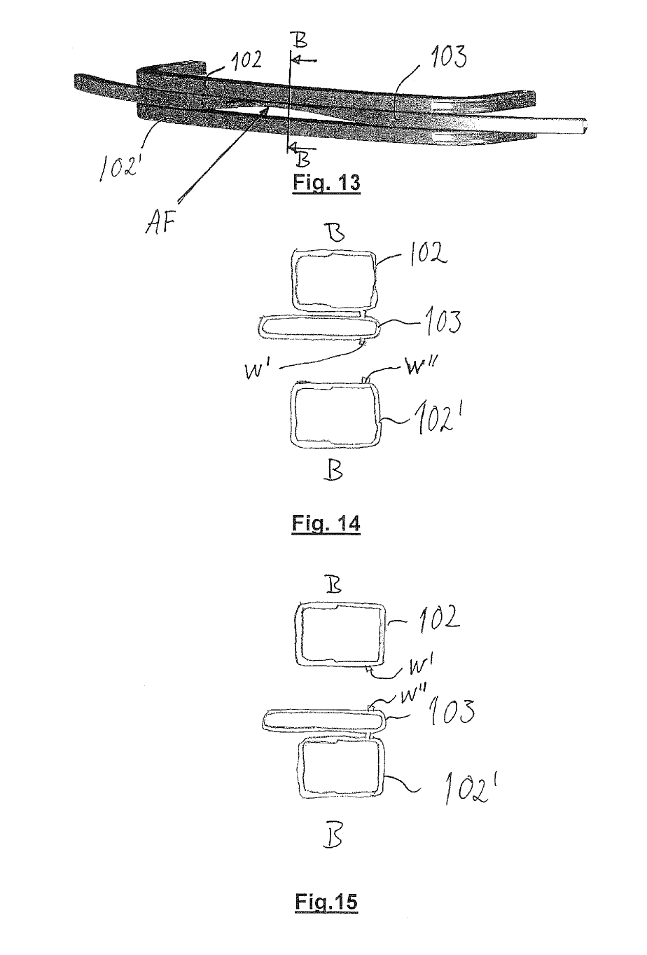

Referring to FIG. 3, the crash management system 1 has a first bumper beam 2 and crash absorbing components or crash boxes 4, 5 integrated in one same and single part. Further there is shown a second beam 3, which is also integrated to the first bumper beam. With reference to FIG. 3, it is shown that beams 2 and 3 are integrated by two parallel webs 6, 6′ that in fact represent one additional hollow section. In other embodiments such connection between beams could be provided by one single web, as in the embodiment shown in FIG. 13.

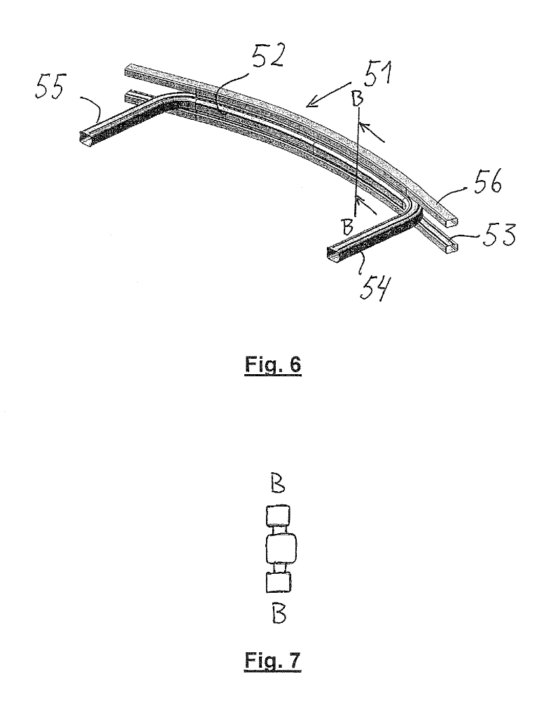

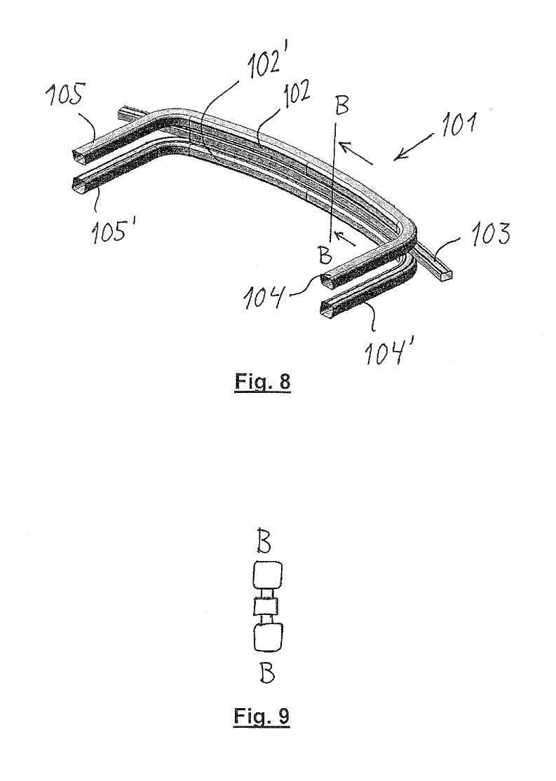

As shown in FIG. 6, there is shown a second embodiment of a crash management system according to the present invention, generally designated by reference numeral 51 by way of a perspective view. FIG. 7 depicts the cross-section configuration of the crash management system, taken along a line B-B in FIG. 6. As shown in FIG. 6, the crash management system 51 has a first bumper beam 52 and crash absorbing components or crash boxes 54, 55 integrated in one same and single part. Further there is shown a second lower beam 53, which is also integrated to the first bumper beam. There is also shown a third, upper beam 56 that is integrated to the first bumper beam.

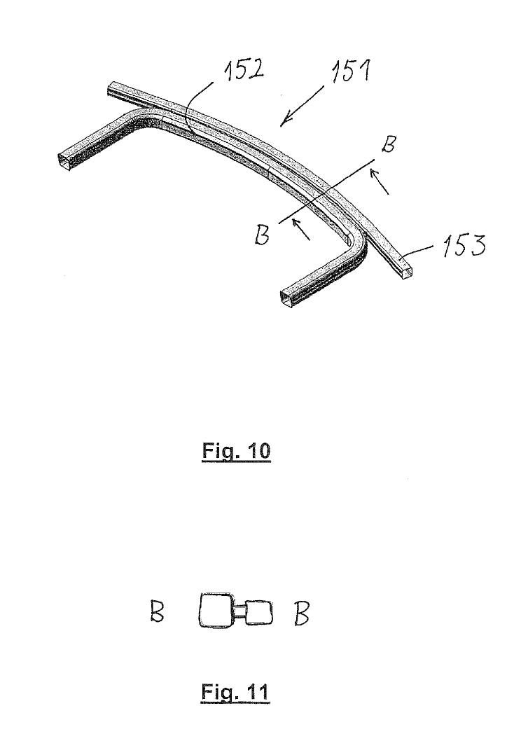

As shown in FIG. 8, there is disclosed a third embodiment of a crash management system according to the present invention, generally designated by reference numeral 101 seen in a perspective view. FIG. 9 discloses the cross-section configuration of the crash management system, taken along a line B-B in FIG. 8. As shown in FIG. 8, the system have a first bumper beam 102 and crash absorbing components or crash boxes 104, 105 integrated in one same and single part. Further there is shown a second beam 103, which is also integrated to the first bumper beam, and below same. In addition there is shown a third, lower beam 102′ that is integrated to the said second beam and further having crash absorbing components or crash boxes 104′, 105′ integrated in one same and single part.

FIG. 10 depicts a perspective view of a fourth embodiment of a crash management system according to the present invention, generally designated by reference numeral 151. FIG. 11 discloses the cross-section configuration of the crash management system, taken along a line B-B in FIG. 10. FIG. 10, the crash management system has a first bumper beam 152 and crash absorbing components or crash boxes 154, 155 integrated in one same and single part. Further there is shown a second beam 153, which is also integrated to the first bumper beam.

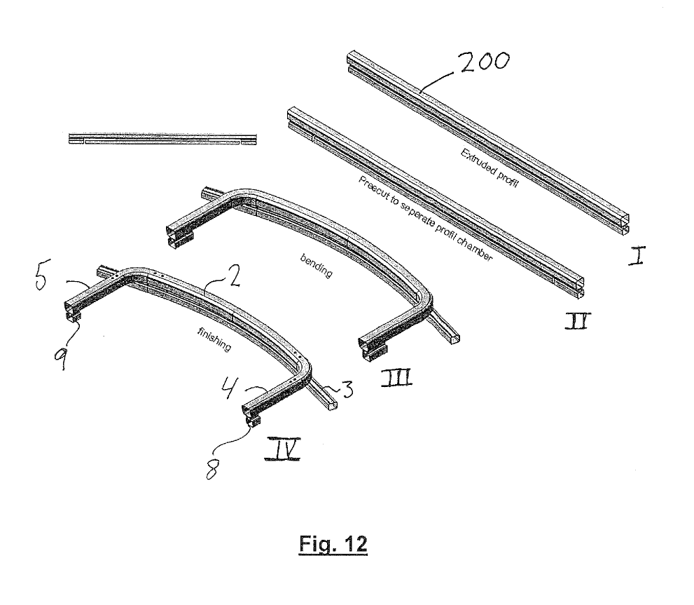

FIG. 12 illustrates a brief overview of the manufacturing process of a crash management system in accordance to the present invention, starting from an extruded section or profile 200 at step I.

At step II, the profile is precut or slit to partly separate one profile chamber from one other.

In step III, the upper part of the profile has been bent backwards at its end regions, to form supporting legs to be attached to a vehicle's frame structure. In the bending process, at least a part of the section that is deformed during bending can be clamped or arrested in a direction perpendicular to the plane of bending. This will influence the folding of said section and also limit the vertical extension of the absorbing member in this area.

It is important to emphasize that the way in which the bending process of the system is done will have a very important influence on the stiffness of the crash management system.

When performing the bending action of one end of the profile, starting from the rectangular section of the extruded profile, an evolutive deformation can be done in one of the walls so that the wall has two crests and one bottom between them.

In a second step, it could be applied simultaneously a deformation (e.g. imprints) in two walls (upper wall and lower wall) of the profile by applying a force to prepare the deformation of the profile in the bending zone. Thereafter a bending of the extremity of the component is performed in such a way that the final form of the component should look as in step III and IV. The same procedure is applied to the other end of the profile.

An important point out of this final form is that it is ensured that the transversal section is in contact with the longitudinal section. In that manner, the system is as stiff as any other comparable solution known from prior art.

Making imprint(-s) or deformation(-s) before bending has shown to support controllable deformation of the section to be deformed during bending.

In a second embodiment of bending, after an evolutive deformation has been done in one of the walls so that the wall has two crests and one bottom between them, an imprint can be applied in the rear wall of the profile (not shown). In a subsequent step, the profile is bent while having a mandrel inside.

The lower part is slightly bent to have a shape that can be conformed with the inner fascia of the vehicle's front and/or for load carrying demands. This beam can advantageously carry other modules, such as lights, cooler, air duct, etc.

Step IV is a finishing step, where mounting holes for sensors, attachment bolts etc. are made in the relevant parts of the system.

The crash management system formed here is similar to that of FIG. 3, with a first bumper beam 2 and crash absorbing components or crash boxes 4, 5 integrated in one same and single part together with a second beam 3. In addition there is shown enlargements 8, 9 at the ends of the crash absorbing components 4, 5 respectively, due to the manufacturing process. The enlargements 8, 9 increase a connecting surface with the vehicle, as well as stiffness in this area of the crash management system.

The crash management system can be made of aluminum or an Al-alloy, in particular age hardening alloys of 6xxx, for instance AA6063 or 7xxx alloys such as AA7003.

FIG. 13 illustrates a crash management system similar to that of FIG. 8, in a first embodiment adapted for airflow to pass through the system. Here the second beam 103 which is arranged between the first bumper beam 102 and the third, lower beam 102′, is cut partly away from the lower beam and compressed in its vertical direction to allow an air flow AF to pass through the crash management system.

FIG. 14 illustrates, on an enlarged view, a cross-section configuration of the crash management system shown in FIG. 13, where a web w′, w″ between the beam 103 and 102′ has been cut to allow the forming of beam 103.

FIG. 15 illustrates, on an enlarged view, a first alternative cross-section configuration of the crash management system shown in FIG. 13, were a web w′, w″ between the beam 102 and 103 has been cut to allow the forming of beam 103.

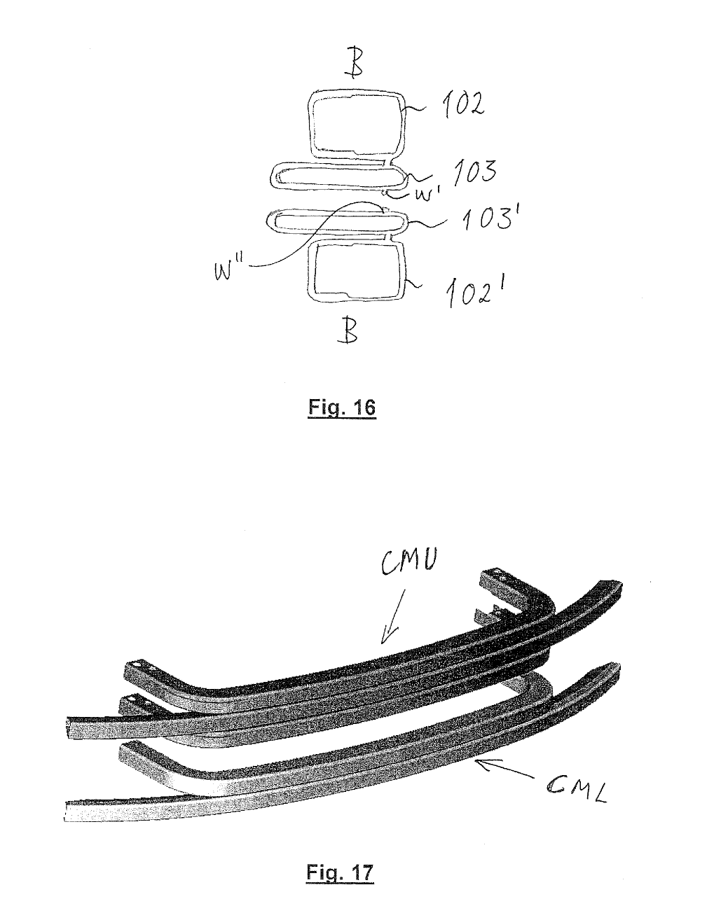

FIG. 16 illustrates, on an enlarged view, a second alternative cross-section configuration of a crash management system similar to that shown in FIG. 13, however having two intermediate beams 103, 103′. As in the foregoing, a web w′,w″ has been cut to allow the spacing between the beams 103, 103′.

FIG. 17 illustrates two crash management systems arranged at different vertical levels, one at an upper level, CMU, and one at one lower level, CML. The upper system can be of the type described in FIG. 8, while the lower system can be similar to that of FIG. 3.

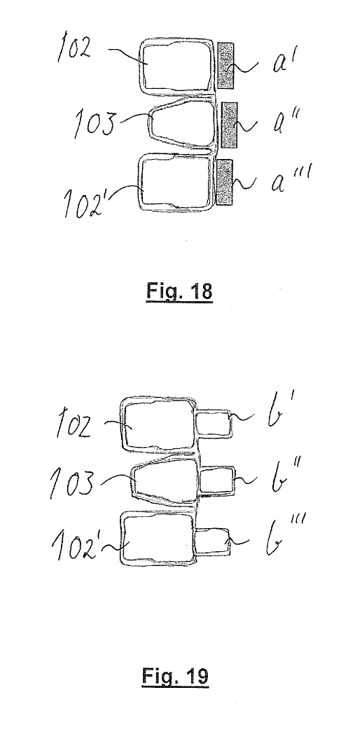

FIG. 18 illustrates a cross-section through a crash management system having absorbing components attached thereto. The system has mainly three beams, similar to the embodiment of FIG. 8. The beams 102, 103, 102′ have absorbing components a′, a″, a′″ attached to them respectively. Such absorbing components may be provided by any appropriate material such as foam, rubber, etc.

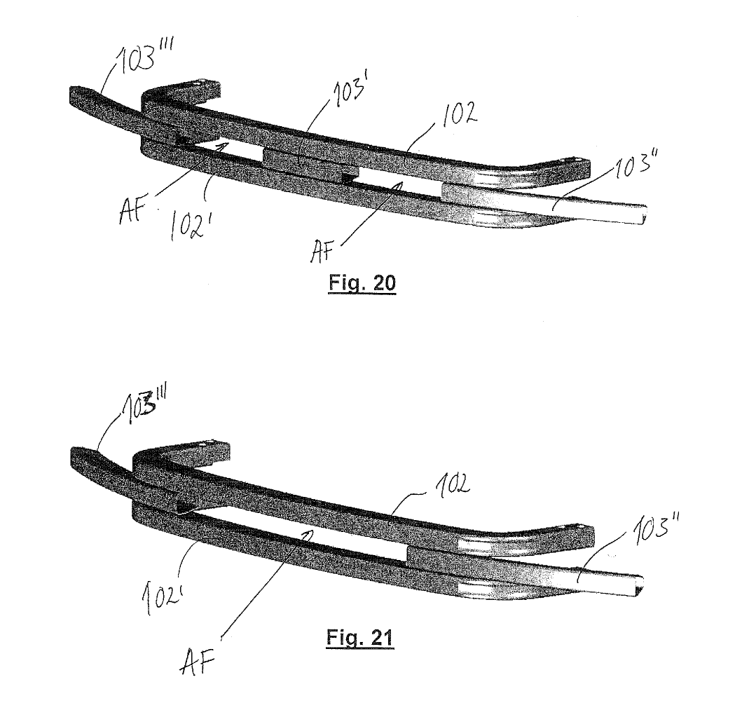

FIG. 19 illustrates a cross-section through a crash management system having absorbing components integrated therein. The beams 102, 103, 102′ have absorbing components b′, b″, b′″ integrated to them respectively. Such absorbing components are in this embodiment provided by relatively soft closed hollow section beams, preferably made as a part of the profile blank.

FIG. 20 illustrates a crash management system similar to that of FIG. 8, in a second embodiment adapted for ventilation. Here two openings for air flow AF are arranged between the first beam 102 and the third, lower beam 102′. The intermediate beam (or second beam) is cut and partly removed, leaving sections 103′, 103″, 103′″ behind.

FIG. 21 illustrates a crash management system similar to that of FIG. 8, in a third embodiment adapted for air flow. Here one opening for air flow AF is arranged between the first beam 102 and the third, lower beam 102′. The intermediate beam (or second beam) is cut and partly removed, leaving sections 103″, 103′″ behind.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A crash management system for a vehicle, comprising:
a first cross-member;
two crash absorbing components connected to the first cross member; and
a second cross-member placed adjacent with the first cross-member.

2. The crash management system of claim 1, wherein the crash absorbing components and the first cross-member form a single-piece construction, with the first cross member having ends which are bent to define the crash absorbing components.

3. The crash management system of claim 1, wherein the second cross-member is arranged below or above the first cross-member.

4. The crash management system of claim 1, wherein the second cross-member is arranged in front of the first cross-member.

5. The crash management system of claim 1, wherein the second cross-member extends beyond the first cross-member in a transverse direction of the vehicle.

6. The crash management system of claim 1, further comprising a third cross-member of a configuration similar to the second cross-member, said first cross-member being arranged in between the second and third cross-members.

7. The crash management system of claim 1, further comprising a third cross-member placed adjacent a first-cross-member-distal surface of the second cross-member and having two crash absorbing components at opposite ends thereof, respectively.

8. The crash management system of claim 7, further comprising a plurality of said second cross-member arranged between the first and third cross-members.

9. The crash management system of claim 6, wherein one of the second cross-member and third cross-member is compressed in its vertical direction in a transversal mid-region.

10. The crash management system of claim 1, wherein plural crash management systems are arranged at different vertical levels at one vehicle's end.

11. The crash management system of claim 1, wherein the first and second cross-members and a third cross member are made of extruded aluminium material.

12. The crash management system of claim 7, further comprising an impact absorbing component arranged at a front side of at least one of the first, second and third cross-members and made of a material which is softer than a material for the at least one of the first, second and third cross-members to provide pedestrian protection.

13. A method for producing a crash management system, comprising the steps of:
producing through extrusion a profile of closed or semi-closed configuration;
cutting a length of the profile to size;
slitting along the profile at locations where sections of the profile are to be separated;
bending the sections to a designed shape; and
providing fixation mounts in the profile.

14. The method of claim 13, wherein the profile is made of an aluminium or aluminium alloy.

15. The method of claim 13, wherein at least one of the sections has ends which are bent to form crash absorbing members to be fixed to a vehicle.
